(19) United States
(12) Patent Application Publication
(10) Pub. No.: US 2002/0059629 A1
(43) Pub. Date: May 16, 2002

(54) Detection and recognition of data receiver to facilitate proper transmission of enhanced data

(76) Inventor: Steven O. Markel, Highlands Ranch, CO (US)

Correspondence Address: The Law Offices of William W. Cochran, Suite 230, 3555 Stanford Road, Fort Collins, CO, 80525, US

(21) Appl. No.: 09/934,354

(22) Filed: Aug. 20, 2001

Related U.S. Application Data
(60) Provisional application No. 60/227,062, filed on Aug. 21, 2000.
(60) Provisional application No. 60/227,930, filed on Aug. 25, 2000.
(60) Provisional application No. 60/228,002, filed on Aug. 25, 2000.
(60) Provisional application No. 60/227,063, filed on Aug. 21, 2000.

(51) Int. Cl. H04N 7/173

(52) U.S. Cl. 725/100; 725/131

(57) ABSTRACT

Disclosed is a method and device to determine which type of Set-Top Box (STB) is used in conjunction with an interactive television signal to convey code that has been developed for that specific STB. The STB is in effect, interacting with the transmission point to identify itself, and in certain circumstances, issue a request for information so that a signal or code developed for that specific receiving unit may be delivered to it. More specifically, the aforementioned invention discloses methods and devices to make these determinations on either the server side or the client side of the system.

### CROSS REFERRENCE TO RELATED APPLICATIONS

This application is based upon and claims priority of provisional application Ser. No. 60/227, 062, entitled “Set Top Box Agnostic Sniffer”, filed on Aug. 21, 2000, provisional application Ser. No. 60/227,930, entitled “System and Method for Web Based Enhanced Interactive Television Content Page Layout”, filed on AuG. 25, 2000, provisional application Ser. No. 60/228,002, entitled “System and Method for Emulating Enhanced and Interactive Television Events, Applications, Packages and Content”, filed on Aug. 25, 2000, and provisional application Ser. No. 60/227,063, entitled “Data Driven System and Method for Distribution of Interactive Content to Multiple Targeted Presentation Platforms”, filed on Aug. 21, 2000. Each of these applications is specifically incorporated herein by reference for all that they disclose and teach.

### BACKGROUND OF THE INVENTION

1. Field of the Invention

The present invention generally pertains to enhanced television and particularly to the determination of which type of Set-Top Box (STB) is used in conjunction with an interactive television signal to convey code that has developed for that specific STB.

2. Description of the Background

Consumers may have any number of different types of receiving units with which they interface every day. Items such as televisions, cell phones, personal data assistants (PDA) and global positioning systems GPS are but a few examples of the type of receivers that we utilize on a daily basis. In each of these instances, the receiving unit generally acts as a passive receiver of content that is transmitted from some type of client server. With the advent of highly sophisticated and specialized receiver units, in combination with ever increasing numbers of types and brands being developed, the need for superior signal specificity has greatly increased. Service providers now must address issues of coverage and compatibility for many different manufacturers, hardware configurations, operating systems and software versions.

For example, consumers may have any number of different STBs attached to their televisions in order to receive enhanced and interactive television content. Within the United States, at least, consumers can obtain a STB supplied by their cable company, or purchased from leading retail stores. Different STBs will run a version of software from WebTVTM, AOLTVTM, UltimateTVTm, and others. These “flavors” of software are incompatible with one another, in that some will support a limited Hyper Text Mark-up Language (HTML) version 4 and JavaScript 1.2, while others support only HTML 3.2 and JavaScript 1.1. The STB receiver includes a TV tuner with a web browser, and is controlled by an operating system that allows the hardware to either feed a video signal straight through or to merge or blend the video signal with an HTML page and display it as a video signal. For example, WebTV utilizes a Microsoft operating system (a subset of Windows), Internet Explorer browser that supports HTML version 4.0 and JavaScript version 1.2 where AOLTV uses a Liberate operating system, HTML version 3.2 and JavaScript version 1.1.

The enhanced content delivered to the STB must of course be developed based on its requirements. Traditionally, content enhancers that enhance specific television content will do it for a specific STB (e.g., the Hollywood Squares game show is enhanced for those running WebTV). The disadvantage to this approach is that any other STB will not display the enhanced content correctly. It would therefore be advantageous to provide a method by which content could be developed for all the supported STBs, with HTML and JavaScript for each supported STB being delivered to that and only that STB.

While numerous examples of detecting type and version of browsers exist, this art teaches only detecting various browsers such as Microsoft Internet Explorer and Netscape Navigator. They do not address STBs or enhanced television. Other examples of methods for use with television content enhancements may be found at various web sites, where a method for redirecting the browser (in this case a WebTV STB) to a different page is discussed. None of these examples disclose the ability to determine if the content relates to enhanced programming in a format acceptable to the STB in use. In all of the current applications, if the content is selected and the enhanced programming in a format unacceptable to the STB, the TV display not display the information correctly.

### SUMMARY OF THE INVENTION

The present invention overcomes the disadvantages and limitations of the prior art by providing methods and devices for determining proper communication protocols between a client receiver and a service provider. This is accomplished by using either active or passive methods by presenting an STB, specific HTML and JavaScript code. In accordance with a first method, called the Client Side Method (CSM), the STB determines its model type, and after making that determination, the STB requests the proper HTML and JavaScript pages. In the second method, called the Server Side Method (SSM), the server that is hosting the content for all the different STBs determines which model is making a request for HTML and JavaScript content, and based on this determination, delivers the correct code to the specific STB.

In the present invention, the client STB has the ability to communicate with the enhanced television service provider in an active or passive sense. This communication can be performed either on the client or server side to identify and configure proper reception of enhanced data and to accommodate and maximize the capabilities of the STB receiver. This contact can be an interactive communication executed in a protocol standard for the specific receiver type. In the instance of interactive TV, the communication is Hyper Text Transfer Protocol (HTTP) which may include, but is not limited to content code transmission in HTML, JavaScript, ASCI or Binary code or any number of additional transmission types. In the CSM, the incoming video signal contains an embedded string of commands that is placed in the Video Blanking Interval (VBI) of the video input signal. This command string is written in Advanced Television Enhancement Forum (ATVEF) compliant code and triggers the STB. References made here in to the ATVEF specifications are made for illustrative purposes only, and such references should not be construed as an endorsement, in any manner, of the ATVEF specification. The STB then internally establishes its identity and would request enhanced content specific to its brand and model type.

In the SSM the incoming video signal also contains an embedded string of ATVEF compliant commands in the VBI to trigger the STB. The STB then communicates directly with the server through HTTP in response to inquiries that would allow the server to establish the STB's existence, it's identity, location or IP address, and its request for enhanced content. The enhanced TV content specific to the identity of the requesting STB is then accessed and conveyed to the receiver.

In accordance with one embodiment of the present invention, a method for delivering specific enhanced content to a set-top box is provided whereby the content can be correctly utilized by the set-top box comprising, receiving a trigger included in a video signal input at the set-top box that indicates enhanced content is available, establishing a communication link between a server operated by a data service provider and the set-top box, identifying the set-top box through this communication link; responding by this server to the identification by transmitting the enhanced content to the set-top box, receiving enhanced data content by the set-top box for generation of an enhanced display.

Also, in accordance with another embodiment of the present invention, a system for delivering specific enhanced content to a set-top box is provided whereby the content can be correctly utilized by the set-top box comprising: a set-top box that receives a trigger encoded in a video signal indicating that enhanced content is available, and in response to this trigger sends a signal containing header information conveying identification and location information of the set-top box, a server that receives the signal and responds to the signal by transmitting enhanced content to the set-top box, wherein the set-top box receives the enhanced content and generates an enhanced display.

An additional embodiment of the present invention employs the application of the aforementioned communication between the client receiver and a service provider where the client is a cellular telephone and the server is a cellular telephone service provider. In this particular embodiment, the CSM is performed by having the client telephone determine which model it is and upon making that determination, the cellular telephone requests the proper enhancements or customizations which might be available for that particular cellular telephone model. The SSM implementation of this embodiment would involve the cellular service provider, determining specific receiver information by communication with the client receiver, and based on this determination deliver the proper enhancements or customizations which might be available for that particular cellular telephone model. These enhancements or customizations may include specific hardware augmentation features but may also include user profile information that could allow for a wide variety of customizations which are very specific to the client or client location. For example, a client who accesses their cellular telephone from a remote location that they might not be familiar with, would have the ability through either a CSM or SSM communication with their service provider, to be given information concerning driving directions, weather info, hotel and restaurant information, stock quotes or a wide variety of useful information which might be of interest to the user.

A further embodiment employs the application of the aforementioned communication between the client receiver and a service provider where the client is a wireless Personal Computer (PC) or Personal Data Assistant (PDA) and the server is an Internet Service Provider (ISP). In this particular embodiment, the CSM is performed by having the client PC or PDA determine which model it is and upon making that determination, the PC or PDA requests the proper operating system, enhancements or customizations which might be available for that particular model. The SSM implementation of this embodiment would involve the ISP acting as the server. The transmitter may determine specific receiver information by communication with the client receiver, and based on this determination deliver the proper operating system, enhancements or customizations that might be available for that particular PC or PDA model. These enhancements or customizations may include specific hardware augmentation features but may also include user profile information that could allow for a wide variety of customizations which are very specific to the client or client location. For example, a client who accesses their PC or PDA from a remote location which they might not be familiar, would have the ability through either a CSM or SSM communication with their service provider, to receive information concerning driving directions, weather info, hotel and restaurant information, stock quotes or a wide variety of useful information which might be of interest to the user.

A further embodiment employs the application of the aforementioned communication between the client receiver and a service provider where the client is a satellite based receiver such as a GPS or Satellite Radio and the server is a transmitter of satellite data. In this particular embodiment, the CSM is performed by having the client GPS or Satellite Radio determine which model it is and upon making that determination, the GPS or Satellite Radio requests the proper operating system, enhancements or customizations which might be available for that particular model. The SSM implementation of this embodiment would involve the transmitter of satellite data acting as the server. The transmitter may determine specific receiver information by communication with the client receiver, and based on this determination deliver the proper operating system, enhancements or customizations which might be available for that particular GPS or Satellite Radio model. These enhancements or customizations may include specific hardware augmentation features but may also include user profile information that could allow for a wide variety of customizations which are very specific to the client or client location. For example, a client who accesses their GPS or Satellite Radio from a remote location with which they might not be familiar, would have the ability through either a CSM or SSM communication with their service provider, to receive information concerning driving directions, weather info, hotel and restaurant information, radio stations or a wide variety of useful information which might be of interest to the user.

An advantage of the present invention is that it allows any type of STB that a consumer might have to work with any server system that has been programmed to recognize that particular STB model. Issues concerning the incompatibility of different STB model types are overcome in the present invention. Interactive TV clients, who now are forced to buy a multitude of different STB models fully utilize content which is specific to each, will now be able to buy just one STB and overcome current limitations of universality. More specifically, the enhanced pages consisting of HTML and JavaScript can be delivered to the appropriate STB seamlessly and invisibly to the user. Furthermore, the specific capabilities that a particular STB can utilize can be exploited, while limitations of another STB can be compensated. Upgrades to current STB models that have the ability to utilize the features of the present invention, could be established through service providers.

### BRIEF DESCRIPTION OF THE DRAWINGS

In the drawings,

FIG. 1 is a schematic block diagram of portion of the overall system of the present invention.

FIG. 2 shows a representation of enhanced television content.

FIG. 3 is a schematic block diagram of one embodiment of the system where only one type of signal is viewable.

FIG. 4 is a schematic block diagram of another embodiment of the present invention.

FIG. 5 is a flow diagram showing the client side method for retrieving the HTML and JavaScript files for a specific set top box.

FIG. 6 illustrates the organization of the HTML and JavaScript pages on the web server for the client side method.

FIG. 7 is a flow diagram showing the server side method for retrieving the HTML and JavaScript files for a specific set top box.

FIG. 8 illustrates the organization of the HTML and JavaScript pages on the web server for the server side method.

FIG. 9 is a schematic block diagram of another embodiment of the present invention.

FIG. 10 is a flow diagram showing the client side method for retrieving enhanced data for a specific remote receiver.

FIG. 11 is a flow diagram showing the server side method for retrieving enhanced data for a specific remote receiver.

### DETAILED DESCRIPTION OF THE PREFERRED EMBODIMENT OF THE INVENTION

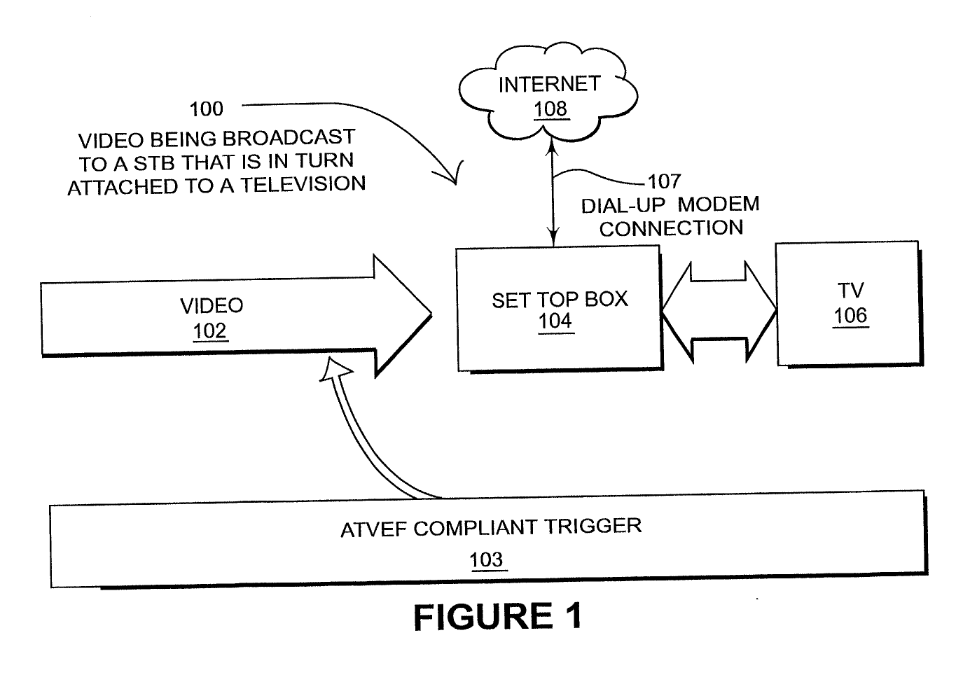

FIG. 1 is a flow diagram illustrating the manner in which a video broadcast 102 is sent to a Set Top Box (STB) receiver 104. Embedded into the VBI of the input video signal 102 is an ATVEF compliant trigger 103, which any ATVEF compliant STB will recognize. The method of embedding a trigger signal is accomplished with software programs such as ITV Producer™ available from Intellocity Inc., 1400 Market Street, Denver, Col. 80202 and with encoders from Norpak, 10 Hearst Way, and Kanata, Ontario, Canada K2L 2P4. The STB 104 receives the enhanced video signal using conventional television reception techniques. The video signal is stripped of the trigger by the STB 104, if one is present, and presented to the television 106. If a trigger 103 was present in the video signal 102, then the STB 104 parses the trigger and based on the trigger information, can go out through the STB back channel 107, typically a dial up modem, DSL or TI connection, or satellite link to the Internet 108 to retrieve specific content consisting of HTML pages that could have JavaScript instructions.

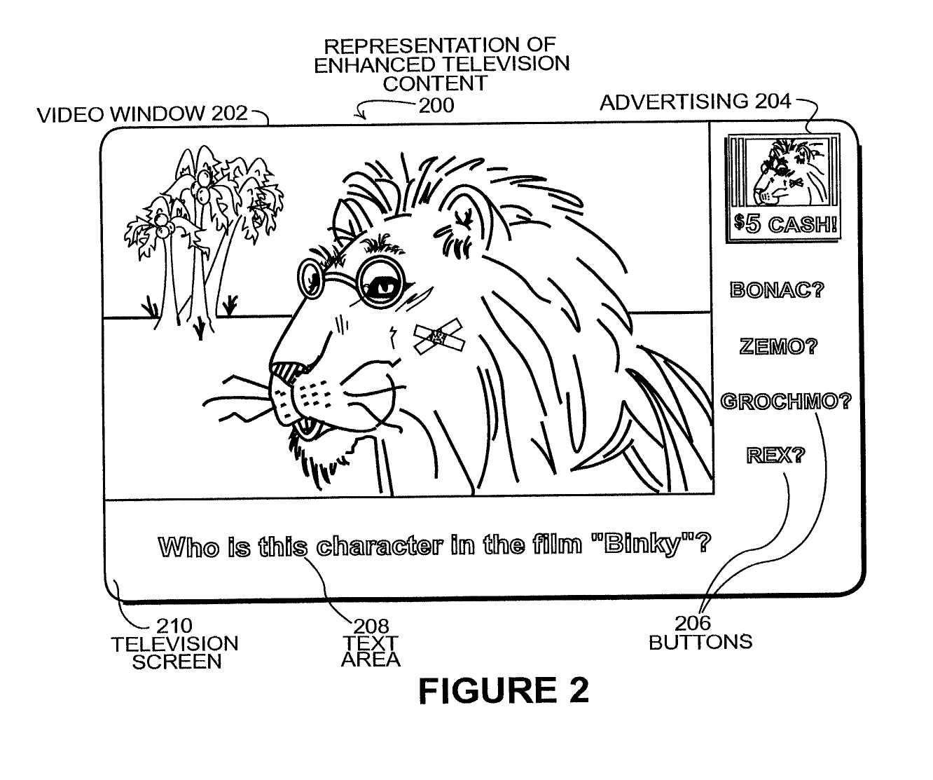

FIG. 2 is an example of a page of enhanced content 200. The video window 202 presents the video as would normally be seen on a television, but the video would typically not occupy the full space of the television screen 210. Advertising logo graphics 204 can be shown on the screen (e.g., an offer to get cash back if you rent the video) as well as graphics or text buttons 206 and text areas 208.

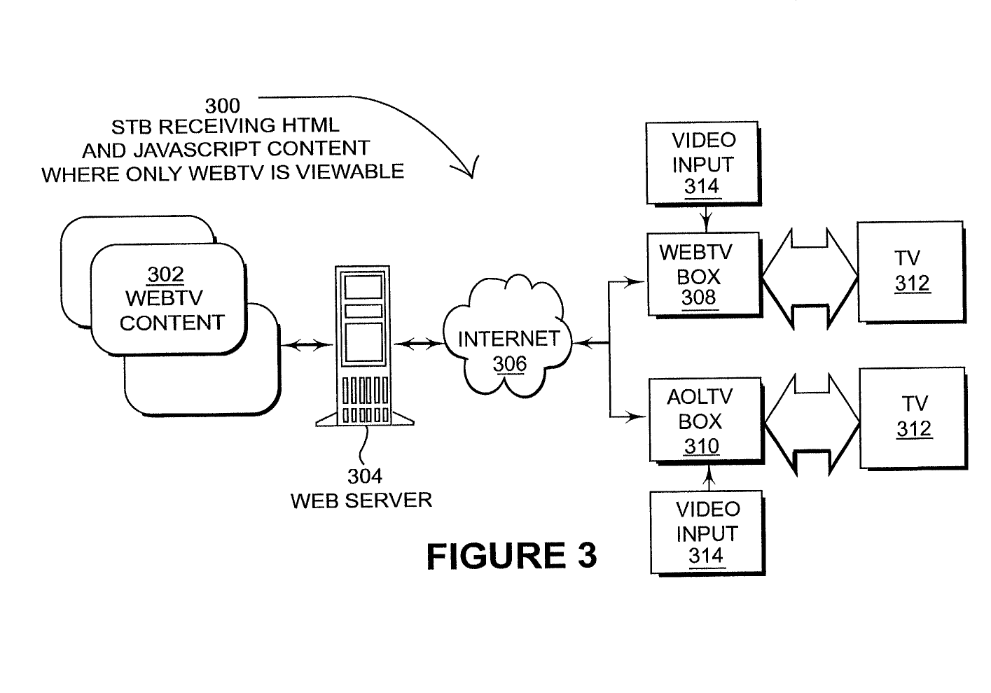

FIG. 3 is a schematic block diagram illustrating the system where only one type of signal is viewable. FIG. 3 illustrates STBs 308, 310 receiving HTML and JavaScript content 300. Specifically, the data flow between various STBs 308 and 310, and the Internet 306 connected to a web server 304 hosting WebTV enhanced content 302. As shown in FIG. 3, the STB 308, in this case a WebTV model makes a request over the Internet 306 for a page of enhanced content 302 being hosted on a web server 304. The content 302 is WebTV specific data, so the WebTV STB 308 displays the enhancements combined with the video signal 314 correctly on television 312. However, in the case where STB 310 is an AOLTV STB, the request and the data follow the same route. But this instance the AOLTV STB 310 will not be able to display the content correctly since the content was written for a WebTV STB 308. Therefore, a separate AOLTV web server is required in order to display enhancements with the video input 314 for the STB 310 on television 312.

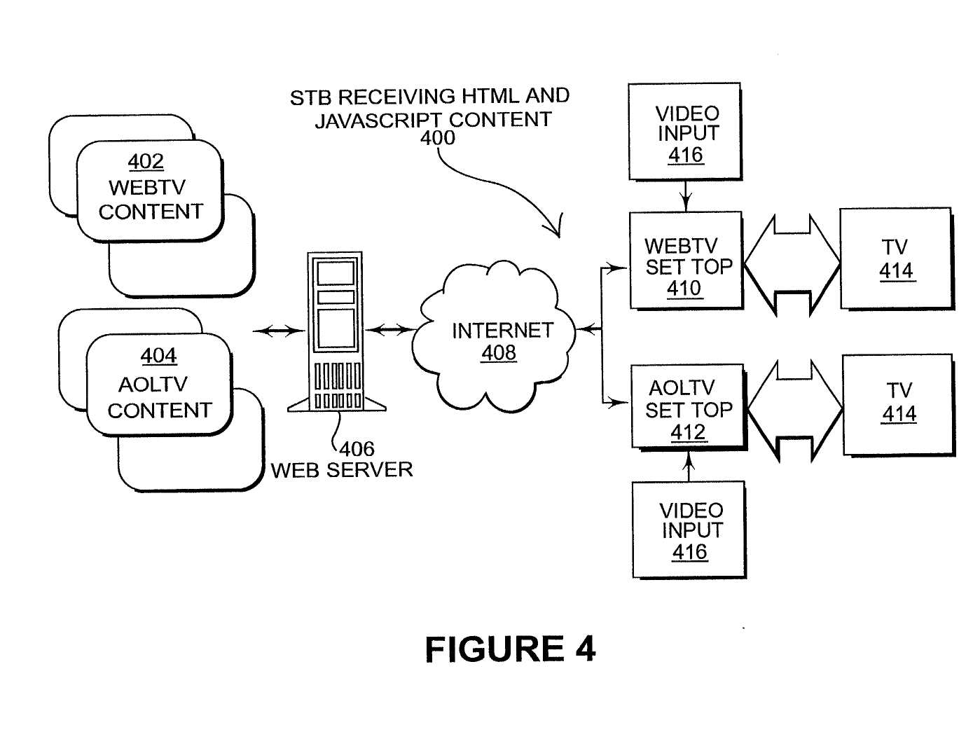

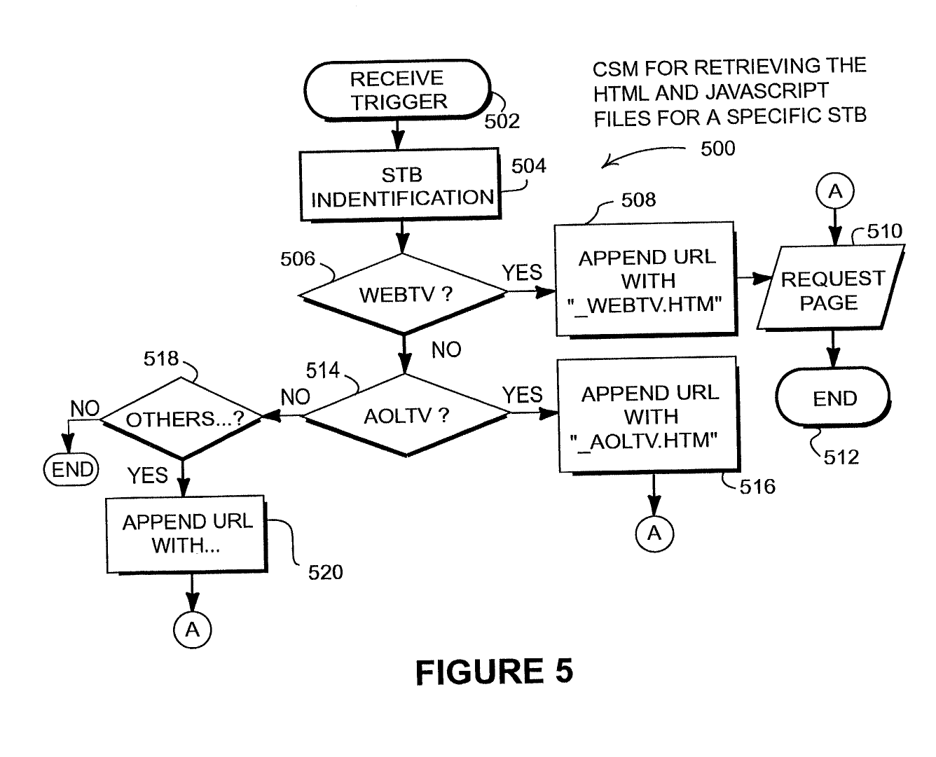

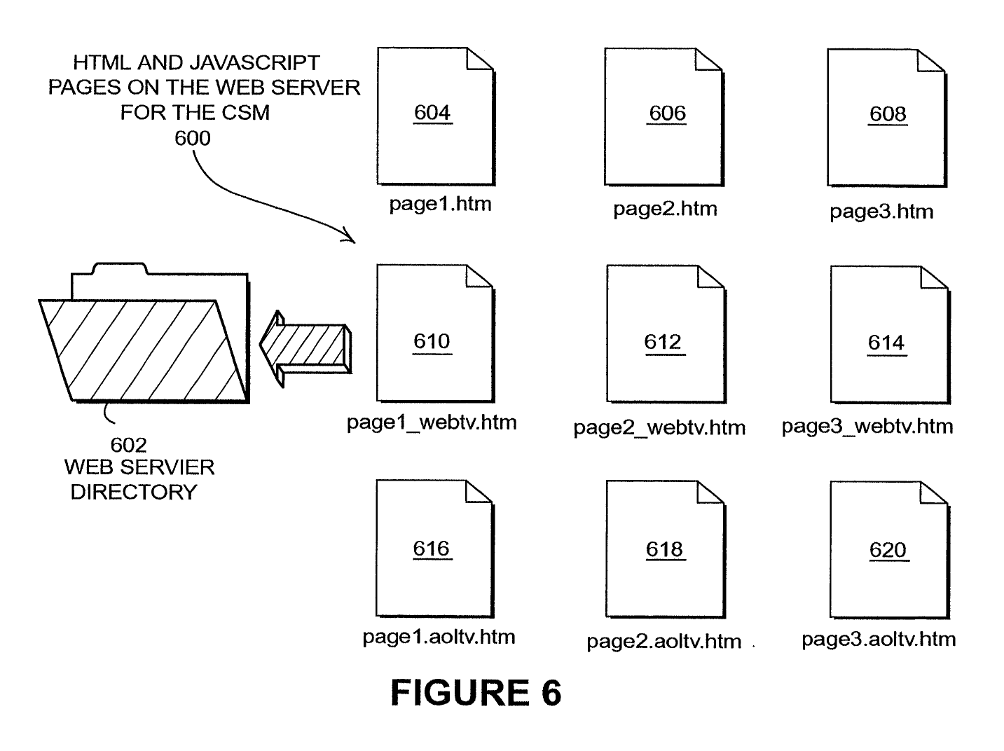

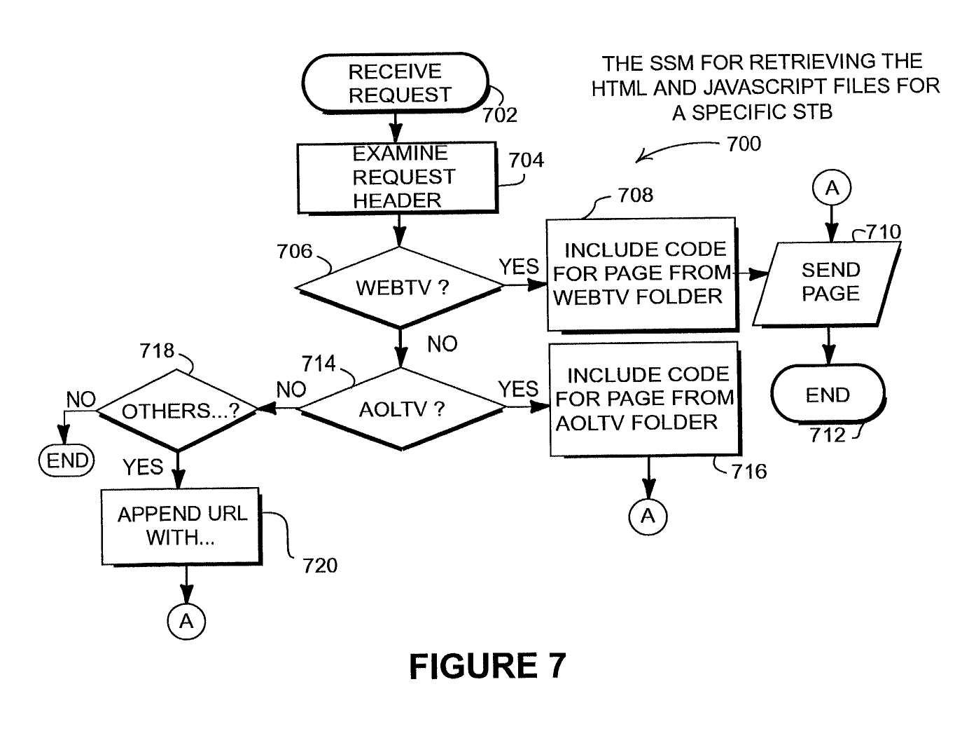

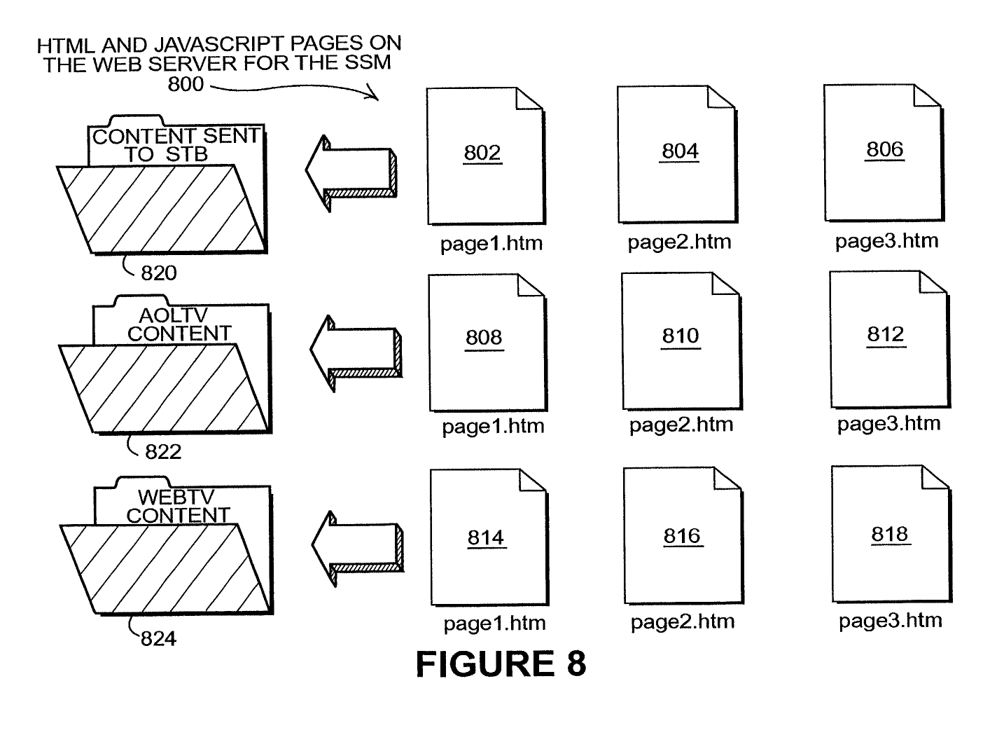

FIG. 4 is a schematic block diagram illustrating components of the present invention. FIG. 4, illustrates an STB 410, 412 receiving HTML and JavaScript content 400. The WebTV STB 410 makes a request for enhanced content 402 and it is delivered through the web server 406 that is attached to the Internet 408. Should a different STB model (e.g. AOLTV) 412 make the same request for the same page, content that has been specifically built for that STB 404 is delivered back to the STB 412. There are two methods used in accordance with the present invention that can accomplish the delivery of WebTV content 402 to a WebTV STB 410 and AOLTV content 404 to an AOLTV STB 412. The first method is called the client side method (CSM), illustrated in FIGS. 5 and 6, and the second is the server side method (SSM), illustrated in FIGS. 7 and 8.

FIG. 5 shows a flowchart of the CSM whereby the STB itself determines and requests which HTML and JavaScript file to retrieve. FIG. 5, illustrates a CSM of retrieving the HTML and JavaScript files for a particular model of STB 500. This methodology assumes that the HTML and JavaScript pages for each of the various STBs has already been created, published and are available on a web server similar to the organization shown in FIG. 6. Each of the file names (for example pagel .htm, page2.htm, page3.htm, . . . ) is appended with the STB identification for which it was created. For example, the pagel.htm page is referred to in the trigger as pagel.htm, but named pagel_webtv.htm for the WebTV implementation, pagel_aoltv for AOLTV, and so on. With these assumptions met, the software within the STB receives a trigger at step 502. This trigger 502 is an embedded string of commands that are placed in the Video Blanking Interval (VBI) of the input video signal. This command string is written ATVEF compliant code and triggers the STB. It is comprised of HTTP that includes content code transmission in HTML. By looking at certain properties of a standard programming object, known as the Navigator Object as defined in JavaScript, the STB can effectively identify the model and IP address of the STB at step 504. The software executes a logical decision 506 determining if the STB is WebTV compliant. A true answer to this logical decision will then take the URL page referred to in the trigger at step 502 and append a “_webtv.htm” 508 to the end of it. After this is been done, the STB will send out a request at step 510 for that specific WebTV HTML and JavaScript page and the code segment ends at step 512. However, if the logical decision at step 506 failed, then another logical decision at step 514 will be made to determine if the STB is AOLTV. If the decision is true, then instead of step 508 appending a “_webtv.htm” to the end of the file referenced in the trigger at step 502, it will instead, append a “_aoltv.htm” 516 to the end of the file referenced in the trigger at step 502. Program control is then branched back to step 510 where the specific program is fetched and again, the segment ends at step 512. Should the STB not be WebTV or AOLTV, the checking can continue for any number of different models of STBs at step 518 to append the URL with an appropriate prefix at step 520 to the trigger at step 502. Program control is then branched back to step 510 where the specific program is fetched and again, the segment ends at step 512.

FIG. 6 illustrates the organization of the HTML and JavaScript pages on the web server for the CSM 600. In this illustration, the Web Server Directory 602 contains the published HTML and JavaScript pages 604-620 for each of the various STBs. Each of the file names (for example page1.htm 604, page2.htm 606, page3.htm 608, . . . ) is appended with the STB identification for which it was created. For example, the pagel.htm 604 page is referred to in the trigger as pagel.htm, but named page1_webtv.htm 610 for the WebTV implementation, page1_aoltv 616 for AOLTV, and so on.

FIG. 7 is a flow diagram showing the SSM for retrieving the HTML and JavaScript files for a specific STB 700. This methodology assumes that all the HTML and JavaScript pages for each of the various STBs have been already created and published and are available on a web server in the organization similar to that shown in FIG. 8.

With these assumptions met, the software within the web server receives a request at step 702 comprised of an embedded string of commands comprised of HTTP that includes content code transmission in HTML. The server will examine the request header at step 704, and determine from the internal protocol, which is stamped with the source code, the specific model, and the IP address of STB that made the request. The web server software executes a logical decision at step 706 determining if the STB that made the request is WebTV compliant. A true answer to this logical decision at step 706 will execute the instructions for the code pertaining to page l.htm in the directory for WebTV content at step 708, to be extracted and inserted into an empty pagel .htm file. The WEBTV content code in the pagel.htm file is then sent to the requesting STB at step 710, and the code segment ends at step 712.

If the logical decision at step 706 is false, indicating at the request header at step 704 was not WebTV, then the next decision tree at step 714, checks to see if the STB that made the request is AOLTV compliant. A true answer to this logical decision at step 714 will execute the instructions for the code pertaining to pagel.htm in the directory for AOLTV content at step 716, to be extracted and inserted into an empty pagel .htm file. Program control is then branched back to step 710 where The AOLTV content code in the pagel.htm file is sent to the requesting STB at step 710, and the code segment ends at step 712.

If the logical decision at step 714 is false, indicating at the request header at step 704 was not WebTV or AOLTV compliant, then the next decision tree at step 718, can continue checking for any number of different models of STBs to include code for appropriate folder at step 720. Program control is then branched back and content code in the pagel.htm file is then sent to the requesting STB at step 710, and the code segment ends at step 712.

In the SSM, each set of pages is stored within separate directories (for example, the pagel.htm page for WebTV is stored in a directory called WebTV or something similar) as shown in FIG. 8. Likewise, the pagel.htm page for AOLTV is stored in a different directory named AOLTV or something similar. However, unlike the client side methodology shown in FIG. 5, the server side does not rename each of the files with an appended string. The page1.htm file is named page1.htm, but the different “flavors” of this file, depend on which STB it was designed for, and are stored in different directories. In the server side method, the STB, instead of asking for “page1_webtv.htm” as it did in FIG. 5, at step 510 (Page Request), now simply sends the request for pagel.htm, which the server receives as shown in FIG. 7, at step702.

FIG. 8 illustrates the organization of the HTML and JavaScript pages on the web server for the SSM 800. FIG. 8 illustrates the Web Server Directories 820-824 containing the published HTML and JavaScript pages 802-818 for each of the various STB types. Each of the file names (for example, page1.htm 802, page2.htm 804, page3.htm 806, . . . ) is placed within the Server Directory corresponding to the appropriate STB identification for which it was created. For example, an STB asking for a page1_webtv.htm as it did in FIG. 5, at step 510 (Page Request), now simply sends the request for page1.htm. Since the server has already determined the STB type, it can direct all the data transmission to the appropriate Web Server Directory 822-824.

The present invention therefore provides two different methodologies to ensure that enhanced content developed for a specific STB is delivered that that STB when requested thus ensuring the viewing of the enhanced content. The present invention allows a content creator to create content that runs on different STBs.

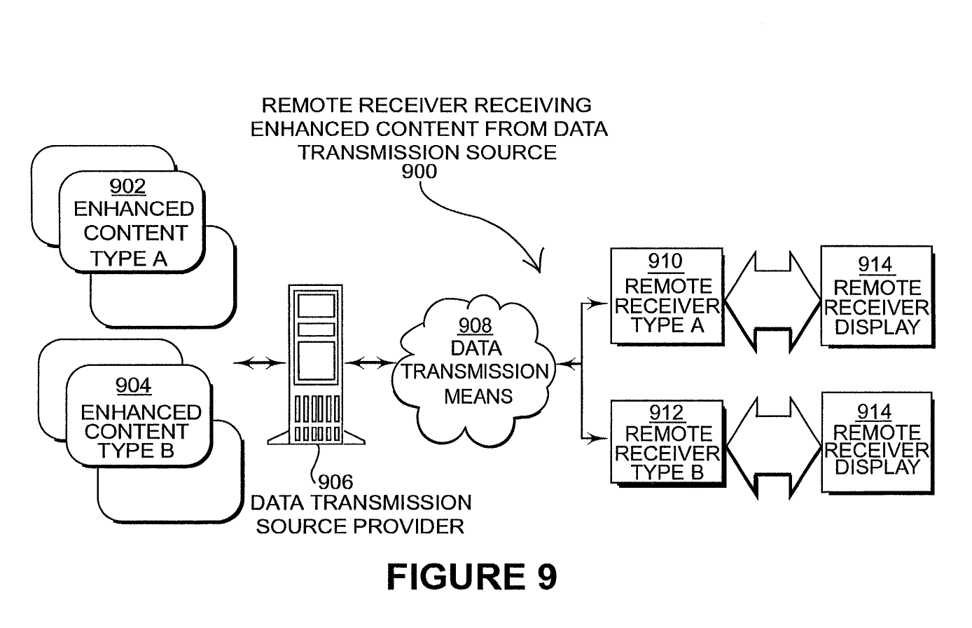

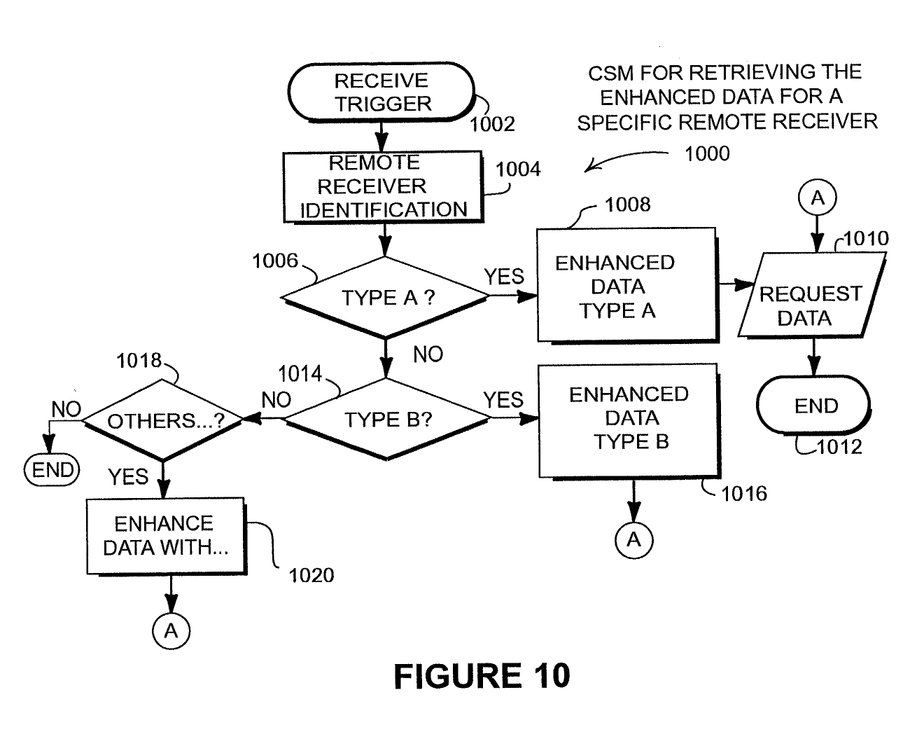

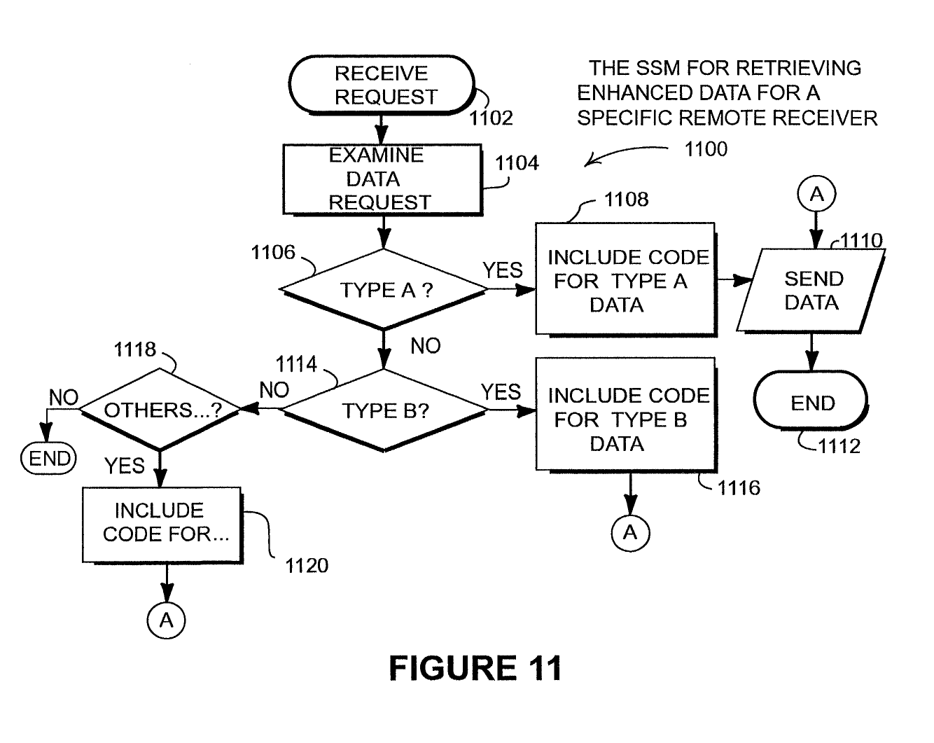

FIG. 9 is a schematic block diagram illustrating components of the present invention. FIG. 9 illustrates a remote receiving unit 910, 912 receiving enhanced content 902, 904 from a data transmission source 900. The Type A remote receiving unit 910 makes a request for Type A enhanced content 902 and it is delivered from the data transmission source 906 that is in communication with a data transmission means 908. Should a different remote receiving model, i.e., Type B 912, make the same request for Type B content 904 that has been specifically designed to enhance this model of remote receiving unit 912, enhanced content Type B 904 is delivered back to the Type B remote receiving unit 912. There are two methods used in accordance with the present invention that can accomplish the delivery of Type A enhanced data content 902 to a Type A remote receiving unit 910 and Type B enhanced data content 904 to a Type B Remote Receiving Unit 912. The first method is the CSM, illustrated in FIG. 10, and the second is the SSM, illustrated in FIG. 11.

FIG. 10 shows a flowchart of the CSM whereby the remote receiver itself determines which enhanced data to retrieve at step 1000. This methodology assumes that the enhanced data for each of the various remote receivers have been already created and are available from the data transmission source. With these assumptions met, the software within the remote receiver, receives a trigger at step 1002. By looking at a property of the data object, the remote receiver can effectively identify what model of remote receiver at step 1004. The software executes a logical decision at step 1006 determining if the remote receiver is data “Type A” compliant. A true answer to this logical decision will then take the data referred to in the trigger at step 1002 and enhance it for the “Type A” remote receiver at step 1008. After this is been done, the remote receiver will send out a request at step 1010 for that specific “Type A” data and the code segment ends at step 1012. However, if the logical decision at step 1006 failed, then another logical decision at step 1014 will be made to determine if the remote receiver is “Type B”. If the decision is true, then instead of at step 1008 enhancing for “Type A” data referenced in the trigger at step 1002, it will instead, enhance it with “Type B” data at step 1016. Program control is then branched back to at step 1010 where the specific program is fetched and again, the segment ends at step 1012. Should the remote receiver not be “Type A” or “Type B”, the checking can continue for any number of different models of remote receivers at step 1018 to enhance the data with an appropriate data “Type” at step 1020 to match the specific remote receiver to the trigger at step 1002. Program control is then branched back to at step 1010 where the specific program is fetched and again, the segment ends at step 1012.

FIG. 11 is a flow diagram showing the SSM for retrieving the enhanced data for a specific remote receiver 1100. This methodology assumes that all the enhanced data for each of the various remote receivers have been already created and are available from the data transmission source. With these assumptions met, the software within the data transmission source receives a request at step 1102. The server will examine the request 1104, and from this information determine the specific model of remote receiver that made the request. The data transmission source software executes a logical decision at step 1106 determining if the remote receiver that made the request is data “Type A” compliant. A true answer to this logical decision at step 1106 will execute the instructions for the code pertaining to “Type A” enhanced data content 1108, to be extracted and sent to the requesting remote receiver at step 1100, and the code segment ends at step 1112.

If the logical decision at step 1106 is false, indicating at the request at step 1104 was not data “Type A”, then the next decision tree at step 1114, checks to see if the remote receiver that made the request is “Type B” compliant. A true answer to this logical decision at step 1 1 14 will execute the instructions for the code pertaining to “Type B” content at step 1116, to be extracted. Program control is then branched back to at step 1110 where The “Type B” content is then sent to the requesting remote receiver at step 1110, and the code segment ends at step 1112.

If the logical decision at step 1114 is false, indicating at the request at step 1 104 was not “Type A”, or “Type B” compliant, then the next decision tree at step 1114, can continue checking for any number of different models of remote receivers at step 1118 to include code for the appropriate remote receiver at step 1120. Program control is then branched back to at step 1110 content is then sent to the requesting remote receiver at step 1110, and the code segment ends at step 1112.

The present invention therefore allows any type of STB to work with any server system that has been programmed to recognize that particular STB model. Interactive TV clients, who now are forced to obtain different STB models such as AOLTV, WebTV and UltimateTV to fully utilize content which is specific to each, will now be able to use just one STB and overcome current limitations of universality. More specifically, the enhanced pages consisting of HTML and JavaScript can be delivered to the appropriate STB seamlessly and invisibly to the user. Furthermore, the specific capabilities that a particular STB can utilize can be exploited, while limitations of another STB can be compensated. Upgrades to current STB models that have the ability to utilize the features of the present invention, could be established through service providers. This would again allow product advantages and enhancements to benefit the consumer without their direct effort.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for delivering specific enhanced content to a set-top box whereby said content can be correctly utilized by said set-top box comprising;
receiving a trigger included in a video signal input at said set-top box that indicates enhanced content is available;
establishing a communication link between a server operated by a data service provider and said set-top box;
identifying said set-top box through said communication link;
responding by said server to said identification by transmitting said enhanced content to said set-top box;
receiving enhanced data content by said set-top box for generation of enhanced display.

2. The method of claim 1 wherein the said signal sent by the set-top box requests specific type content only.

3. The method of claim 1 wherein the server responds to said signal set by said settop box and said server establishes identity of said set-top box and only transmits enhanced content specific to that type of said set-top box.

4. The method of claim 1 wherein said trigger is located in the vertical blanking interval of the video signal input.

5. The method of claim 1 wherein said trigger is a command string written in Advanced Television Enhancement Forum compliant code.

6. The method of claim 1 wherein said communication link is Hyper Text Transfer Protocol.

7. A method for delivering specific enhanced content to a set-top box whereby said content can be correctly utilized by said set-top box comprising;
receiving a trigger included in a video signal input at said set-top box that indicates enhanced content is available; establishing a communication link between a server operated by a data service provider and said set-top box;
sending a signal from said set-top box to said server through said communication link;
decoding a signal header by said server to establish said set-top box 10 identity;
responding by said server to said signal by transmitting said enhanced content corresponding to said identity of said set-top box;
receiving the enhanced data content by said set-top box for generation of an enhanced display.

8. The method of claim 1 wherein said trigger is located in the vertical blanking interval of the video signal input.

9. The method of claim 1 wherein said trigger is a command string written in Advanced Television Enhancement Forumn compliant code.

10. The method of claim I wherein said communication link is Hyper Text Transfer Protocol.

11. A method for delivering specific enhanced content to a set-top box whereby said content can be correctly utilized by said set-top box comprising;
receiving a trigger included in a video signal input at said set-top box that indicates enhanced content is available;
establishing a communication link between a server operated by a data service provider and said set-top box;
sending a signal from said set-top box to said server through said communication link;
decoding a signal header by said server to establish said set-top box identity;
responding by said server to said signal by transmitting said enhanced content corresponding to said identity of said set-top box;
receiving the enhanced data content by said set-top box for generation of an enhanced display.

12. The method of claim 11 wherein said trigger is located in the vertical blanking interval of the video signal input.

13. The method of claim 11 wherein said trigger is a command string written in Advanced Television Enhancement Forum compliant code.

14. The method of claim 11 wherein said communication link is Hyper Text Transfer Protocol.

15. A system for delivering specific enhanced content to a set-top box whereby said content can be correctly utilized by said set-top box comprising;
a set-top box that receives a trigger encoded in a video signal indicating that enhanced content is available, and in response to said trigger sends a signal containing header information conveying identification and location information of said set-top box;
a server that receives said signal and responds to said signal by transmitting enhanced content to said set-top box;
wherein said a set-top box receives said enhanced content and generates an enhanced display.

16. The system of claim 15 wherein the said signal sent by the set-top box requests a specific type of content only.

17. The system of claim 15 wherein the server responds to said signal from said settop box and only transmits enhanced content specific to that type of said set-top box.

18. The system of claim 15 wherein said trigger is located in the vertical blanking interval of the video signal input.

19. The system of claim 15 wherein said trigger is a command string written in Advanced Television Enhancement Forum compliant code.

20. The system of claim 15 wherein said communication link is Hyper Text Transfer Protocol.
